(19) United States
(12) Patent Application Publication
(10) Pub. No.: US 2006/0203204 A1
(43) Pub. Date: Sep. 14, 2006

(54) Image projection apparatus for adjusting white balance in consideration of temperature of LED and method thereof

(75) Inventor: Byung-cheol Yu, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/348,338

(22) Filed: Feb. 7, 2006

(30) Foreign Application Priority Data
Mar. 9, 2005 (KR) 2005-0019693

(51) Int. Cl. G03B 21/16

(52) U.S. Cl. 353/52; 353/85

(57) ABSTRACT

An image projection apparatus for adjusting a white balance in consideration of a temperature of an LED and a method thereof. The image projection apparatus includes a light source unit to sequentially emit lights generated by a red (R)-light emitting element, a green (G)-light emitting element, and a blue (B)-light emitting element. Light levels of the R-light emitting element, the G-light emitting element and the B-light emitting element change depending on changes in temperature. An image generation unit generates an image using the lights sequentially emitted from the light source unit and projects the image. A driving unit drives the light source unit and the image generation unit. A temperature sensor measures a temperature of the light source unit, and a controller controls a driving operation of the driving unit based on the temperature of the light source unit measured by the temperature sensor to adjust a white balance of the image projected from the image generation unit.

### CROSS-REFERENCE TO RELATED APPLICATIONS

This application claims benefit under 35 U.S.C. § 119(a) of Korean Patent Application No. 2005-19693, filed on Mar. 9, 2005, the entire content of which is hereby incorporated by reference.

### BACKGROUND OF THE INVENTION

1. Field of the Invention

The present invention relates to an image projection apparatus and a white balance adjustment method thereof. More particularly, the present invention relates to an image projection apparatus which uses a light emitting diode as a light source and a white balance adjustment method thereof.

2. Description of the Related Art

An image projection apparatus receives an image signal, forms an image corresponding to the image signal, and projects the image onto a screen. Such an image projection apparatus is called a “projector.” The image projection apparatus typically adopts the following image forming process. White light emitted from a white lamp passes through a color wheel. The color wheel filters the white light into red (R)-light, green (G)-light and blue (B)-light in sequence. The R, G, and B-lights are modulated into a corresponding image by a digital micromirror device (DMD).

However, the white lamp has disadvantages of large bulk and high power consumption. Therefore, if the image projection apparatus uses the white lamp as a light source, the volume of the image projection apparatus becomes increased and power consumption is increased. These factors are particularly problematic if the white lamp is used as a light source in a portable image projection apparatus meant to be carried, that uses a battery for power supply.

In order to solve this problem, an image projection apparatus using three color (red, green, blue) light emitting diodes (LEDs) as a light source has been suggested.

However, when the LEDs are driven for a long time, temperatures of the LEDs increase, which causes a reduction in levels of light emitted from the LEDs. The degree of reduction of light level caused by the increase of temperature differs depending on the kind of LEDs and manufacturers of the LEDs. Accordingly, when the image projection apparatus using the LEDs as a light source is in use for a long time, deviations with respect to the levels of light from the red, grebe and blue LEDs become unacceptable.

The unacceptable deviations of light output cause image degradation of the image provided to a user, and also require a white balance to be adjusted.

Accordingly, there is a need for an image projection apparatus that adjusts a white balance in consideration of the temperature of an LED, and a corresponding method thereof.

### SUMMARY OF THE INVENTION

The present invention has been developed in order to solve the above and other known problems in the related art, and to provide additional advantages which will become apparent to one of ordinary skill in the art from the following description. Accordingly, an aspect of the present invention is to provide an image projection apparatus which adjusts a white balance in consideration of a temperature of a light source to prevent an image degradation, and a white balance adjustment method thereof.

The above and/or other aspects are achieved by providing an image projection apparatus including a light source unit to sequentially emit lights generated by a red (R)-light emitting element, a green (G)-light emitting element, and a blue (B)-light emitting element. Light levels of the R-light emitting element, the G-light emitting element and the B-light emitting element change depending on changes in temperature. An image generation unit generates an image using the lights sequentially emitted from the light source unit and projects the image. A driving unit drives the light source unit and the image generation unit. A temperature sensor measures a temperature of the light source unit, and a controller controls a driving operation of the driving unit based on the temperature of the light source unit measured by the temperature sensor to adjust a white balance of the image projected from the image generation unit.

The temperature sensor may be provided around at least one of the R-light emitting element, the G-light emitting element, and the B-light emitting element to measure a temperature of the at least one light emitting element.

The temperature sensor may be provided on a panel to which at least one of the R-light emitting element, the G-light emitting element, and the B-light emitting element is attached.

The image projection apparatus may further include a heat discharging unit to discharge heat generated from at least one of the R-light emitting element, the G-light emitting element and the B-light emitting element, wherein the temperature sensor is provided on at least one of the heat discharging unit and a surrounding portion of the heat discharging unit to measure the temperature of the light source unit.

The driving unit may include a light source driving unit to generate and supply a driving pulse for the respective R-light emitting element, G-light emitting element, and B-light emitting element of the light source unit, thereby driving the light source unit. The controller may determine levels of the driving pulses for the respective R-light emitting element, G-light emitting element, and B-light emitting element based on the temperature of the light source unit measured by the temperature sensor, and control the light source driving unit to generate the driving pulses according to the determined pulse levels.

The driving unit may include a light source driving unit to generate and supply driving pulses for the respective R-light emitting element, G-light emitting elements, and B-light emitting element, thereby driving the light source unit. The controller may determine pulse-widths and starting times of driving pulses for the respective R-light emitting element, G-light emitting element and B-light emitting element based on the temperature of the light source unit measured by the temperature sensor, and control the light source driving unit to generate the driving pulses according to the determined pulse-widths and starting times.

The driving unit may include an image generation driving unit to generate reflection angle adjustment signals to adjust reflection angles for the lights sequentially entering the image generation unit from the light source unit for each pixel, and to supply the reflection angle adjustment signals to the image generation unit such that the image generation unit generates and projects the image. The controller may determine levels of the reflection angle adjustment signals based on the temperature of the light source unit measured by the temperature sensor, and control the image generation driving unit to generate reflection angle adjustment signals according to the determined levels of reflection angle adjustment signals.

The above and/or other aspects of the present invention are also achieved by providing a method of adjusting a white balance of an image projection apparatus comprising a light source unit to sequentially emit lights generated by a red (R)-light emitting element, a green (G)-light emitting element, and a blue (B)-light emitting element, light levels of the R-light emitting element, the G-light emitting element and the B-light emitting element changing depending on changes in temperature, and an image generation unit to generate an image using the lights sequentially emitted from the light source unit and project the image. The method preferably includes a) measuring a temperature of the light source unit, and b) controlling a driving operation of at least one of the light source unit and the image generation unit based on the measured temperature of the light source unit and thereby adjusting a white balance of the image projected from the image generation unit.

Step a) may use a temperature sensor provided around at least one of the R-light emitting element, the G-light emitting element, and the B-light emitting element to measure a temperature of the light emitting element located around the temperature sensor.

Step a) may use a temperature sensor provided on a panel to which at least one of the R-light emitting element, the G-light emitting element, and the B-light emitting element is attached and measure a temperature of the light emitting element located around the temperature sensor.

Step a) may use a temperature sensor provided on one of a heat discharging unit and a surrounding portion of the heat discharging unit to measure a temperature of the light source unit, wherein the heat discharging unit discharges heat generated from at least one of the R-light emitting element, the G-light emitting element and the B-light emitting element.

Step b) may include determining levels of driving pulses for the respective R-light emitting element, G-light emitting element, and B-light emitting element based on the measured temperature of the light source unit, and supplying driving pulses according to the determined pulse levels to the light source unit and driving the light source unit such that a white balance of the image projected from the image generation unit is adjusted.

Step b) may include determining pulse-widths and starting times of driving pulses for the respective R-light emitting element, G-light emitting element and B-light emitting element based on the measured temperature of the light source unit, and supplying the driving pulses according to the determined pulse-widths and starting times to the light source unit and driving the light source unit such that a white balance of the image projected from the image generation unit is adjusted.

Step b) may include determining levels of reflection angle adjustment signals based on the measured temperature of the light source unit, wherein the reflection angle adjustment signals adjust reflection angles for the lights sequentially emitted from the light source unit to the image generation unit for each pixel, and supplying the reflection angle adjustment signals according to the determined signal levels to the image generation unit in order for the image generation unit to generate and project the image, such that a white balance of the image projected from the image generation unit is adjusted.

### BRIEF DESCRIPTION OF THE DRAWINGS

These and/or other aspects of the present invention will become apparent and more readily appreciated from the following description of exemplary embodiments, taken in conjunction with the accompanying drawings of which:

FIG. 1 is a block diagram showing an image projection apparatus which adjusts a white balance in consideration of a temperature of a light emitting diode (LED) according to an exemplary embodiment of the present invention;

FIG. 2A is a flowchart showing a method of adjusting a white balance in consideration of a temperature of an LED according to an exemplary embodiment of the present invention;

FIG. 2B is a flowchart showing a method of adjusting a white balance in consideration of a temperature of a LED according to another exemplary embodiment of the present invention;

FIG. 2C is a flowchart showing a method of adjusting a white balance in consideration of a temperature of a LED according to still another exemplary embodiment of the present invention;

FIG. 3 is a graph showing relationships between light levels and temperatures of LEDs.

FIGS. 4A to 4C are views showing waveforms of LED driving pulses, according to various exemplary embodiments of the present invention;

FIG. 5 is a view showing a light source unit embodied by two temperature sensors according to an exemplary embodiment of the present invention;

FIG. 6A is a view showing a light source unit embodied by one heat discharging unit and one temperature sensor according to an exemplary embodiment of the present invention;

FIG. 6B is a view showing a light source unit embodied by two heat discharging units and two temperature sensors according to an exemplary embodiment of the present invention; and

FIG. 7 is a light source unit embodied by a plurality of LEDs for use with an exemplary embodiment of the present invention.

Throughout the drawings, like reference numbers will be understood to refer to like elements, features and structures.

### DETAILED DESCRIPTION OF EXEMPLARY EMBODIMENTS

Hereinbelow, exemplary embodiments of the present invention will be described in greater detail with reference to the accompanying drawings.

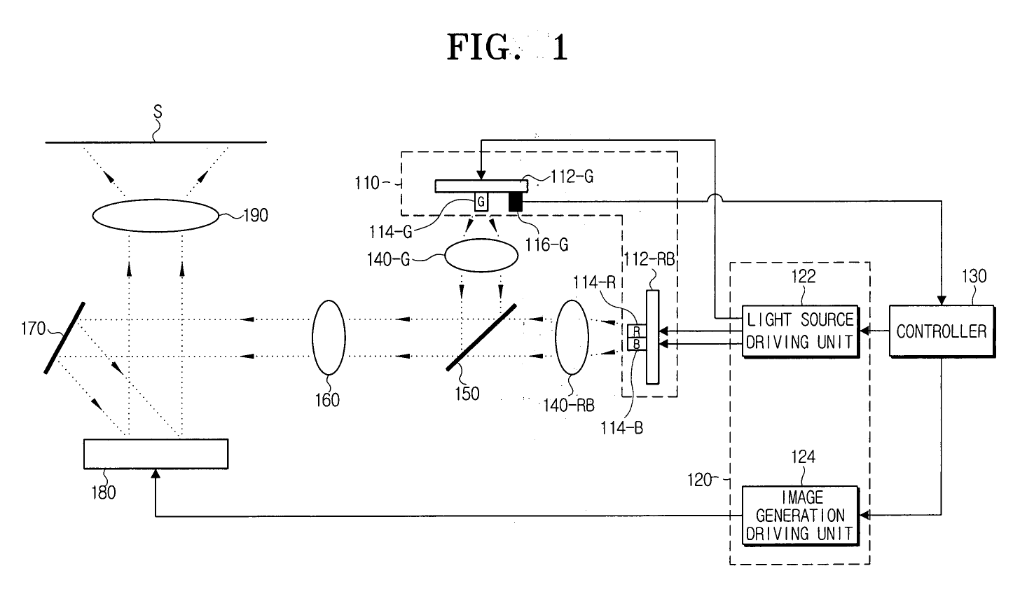

FIG. 1 is a block diagram showing an image projection apparatus according to an exemplary embodiment of the present invention. The image projection apparatus according to an exemplary embodiment of the present invention uses three-color light emitting diodes (LEDs), that is, a red (R)-LED, green (G)-LED, and blue (B)-LED as a light source. The image projection apparatus according to an exemplary embodiment of the present invention takes temperatures of the LEDs into account in adjusting a white balance with respect to a projected image. In FIG. 1, solid-lines indicate paths for electrical signals such as driving signals and control signals, and dotted-lines indicate paths for light beams.

Referring to FIG. 1, the image projection apparatus comprises a light source unit 110, a driving unit 120, a controller 130, a red-blue collimating lens (RB-CL) 140-RB, a green collimating lens (G-CL) 140-G, a light filter 150, a relay lens 160, a reflection mirror 170, an image generation unit 180, and a projection lens 190.

The light source unit 110 generates and emits R-light, G-light, and B-light in sequence. If the image projection apparatus is driven according to the national television system committee (NTSC) scheme, the light source unit 110 emits the R-light for the first 1/180 second (⅓ of frame period), emits the G-light for the second 1/180 second, emits the B-light for the third 1/180 second, and then again emits the R-light for the 1/180 second, and so on. If the image projection apparatus is driven according to the phase alternation by line (PAL) scheme, the light source unit 110 emits the R-light, the G-light and the B-light in sequence in every 1/150 second.

The light source unit 110 comprises a RB-panel 112-RB, a R-LED 114-R, a B-LED 114-B, a G-panel 112-G, a G-LED 114-G, and a G-temperature sensor 116-G.

The R-LED 114-4R and the B-LED 114-B are attached to the RB-panel 112-RB, and they generate and emit R-light and B-light, respectively. The R-LED 114-R and the B-LED 114-B are respectively driven by a R-driving pulse and a B-driving pulse which are generated by a light source driving unit 122 (which will be described below) and transmitted through a connector (not shown) provided in the RB-panel 112-RB.

The G-LED 114-G is attached to the G-panel 112-G and generates and emits G-light. The G-LED 114-G is driven by a G-driving pulse which is generated by the light source driving unit 122 and transmitted through a connector (not shown) provided in the G-panel 112-G.

The G-temperature sensor 116-G measures a temperature of the light source unit 110, and transmits the measurement result to the controller 130, which will be described below. The G-temperature sensor 116-G is preferably located around the G-LED 114-G on the G-panel 112-G to measure a temperature of the G-LED 114-G.

In this embodiment, there is no temperature sensor to measure temperatures of the R-LED 114-R and the B-LED 114-B. This is because the LEDs of the light source unit 110 are driven for the same times and in sequence and thus the LEDs have similar levels of temperatures. That is, since there is no problem if the temperatures of the R-LED 114-R and the B-LED 114-B are assumed to be the same as the temperature of the G-LED 114-G measured by the G-temperature sensor 116-G, no temperature sensor is needed to measure the temperatures of the R-LED 114-R and the B-LED 114-B.

The R-light or the B-light emitted from the R-LED 114-R or the B-LED 114-B is concentrated by the RB-CL 140-RB and passes through the light filter 150. Then, the R or B light is incident on the image generation unit 180 through the relay lens 160 and the reflection mirror 170.

The G-light emitted from the G-LED 114-G is concentrated by the G-CL 140-G and reflected by the light filter 150. Then, the G-light is incident on the image generated unit 180 through the relay lens 160 and the reflection mirror 170.

The image generation unit 180 is driven by an image generation driving unit 124, which will be described below. The image generation unit 180 modulates the sequentially entering R-light, B-light, and G-light to generate an image. The image generation unit 180 projects the image on a screen. More specifically, the image generation unit 180 adjusts reflection angles with respect to the sequentially entering R-light, B-light, and G-light for each pixel to generate an image. The image generation unit 180 is embodied by a digital micromirror device (DMD).

The image is projected from the image generation unit 180 on a screen S through the projection lens 190.

The driving unit 120 drives the light source unit 110 and the image generation unit 180 and comprises the light source driving unit 122 and the image generation driving unit 124.

The light source driving unit 122 generates the R-driving pulse, the G-driving pulse and the B-driving pulse to drive the R-LED 114-R, the G-LED 114-G and the B-LED 114-B, respectively, and supplies the generated driving pulses to the corresponding LEDs, thereby driving the LEDs in sequence.

The image generation driving unit 124 generates reflection angle adjustment signals to adjust the reflection angles with respect to the lights sequentially entering to the image generated unit 180 for each pixel, and supplies the generated reflection angle adjustment signals to the image generation unit 180 such that the image generation unit 180 generates and projects an image.

The controller 130 controls the light source driving unit 122 and the image generation driving unit 124 to adjust a white balance of the image projected from the image generation unit 180. The controller 130 takes the temperature measured by the G-temperature sensor 116-G into account to more appropriately adjust the white balance.

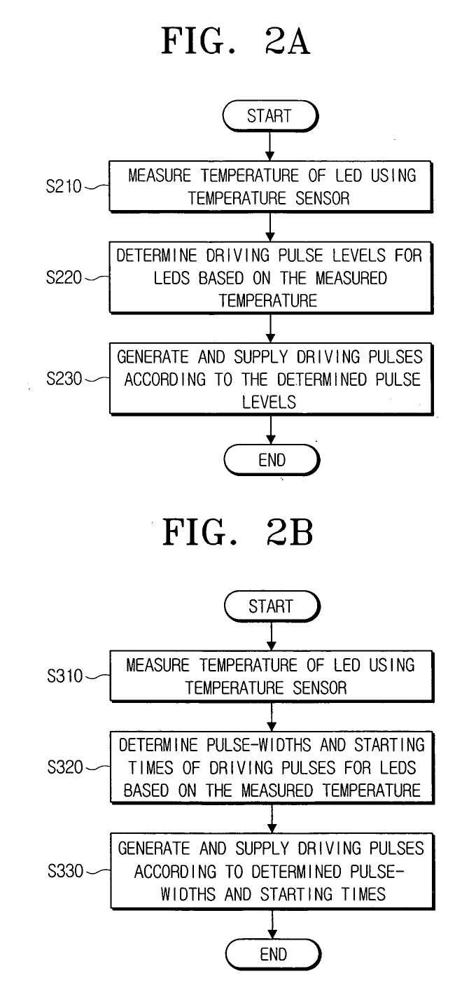

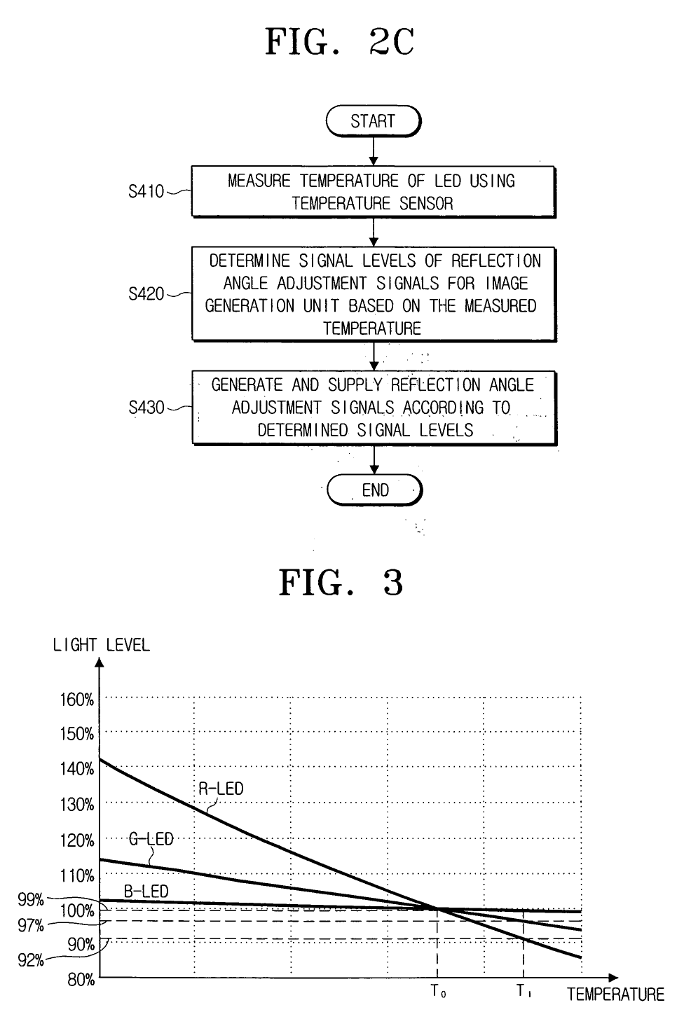

Hereinbelow, a white balance adjustment method of an image projection apparatus according to an exemplary embodiment of the present invention will be described with reference to FIG. 2A. FIG. 2A is a flowchart showing a method of adjusting a white balance in consideration of a temperature of an LED according to an exemplary embodiment of the present invention.

Referring to FIG. 2A, a temperature of the LED is measured by a temperature sensor at step S210. More specifically, the temperature of the G-LED 114-G is measured by the G-temperature sensor 116-G. As described above, the temperatures of the R-LED 114-R and B-LED 114-B are assumed to be the same as that of the G-LED 114-G measured at step S210.

The controller 130 determines levels of driving pulses for the respective LEDs based on the measured temperature at step S220. That is, the controller 130 determines a level of an R-light driving pulse (referred to as “R-driving pulse level” hereinbelow), a level of a G-light driving pulse (referred to as “G-driving pulse level” hereinbelow) and a level of a B-light driving pulse (refereed to as “B-driving pulse level”) based on the measured temperature.

The controller 130 preferably refers to a graph showing characteristics of the LEDs in order to determine the driving pulse levels. FIG. 3 shows changes in light level according to the temperatures of the R-LED 114-R, the G-LED 114-G, and the B-LED 114-B.

In FIG. 3, ‘T₀’ denotes a reference temperature (a normal temperature or a temperature at the beginning of a driving operation of the image projection apparatus). At the temperature ‘T₀’, the R-LED 114-R, the G-LED 114-G, and the B-LED 114-B have 100% of a reference light level.

If the measured temperature increases from ‘T₀’ to ‘T₁’, the R-light level, the G-light level and the B-light level decrease below 100% of the reference level. The decrease rate is different depending on the LEDs. More specifically, the R-light level has the highest decrease rate, whereas the B-light level has the lowest decrease rate. That is, if the temperature increases, the R-light has the highest decrease in light level and the B-light has the lowest decrease in-light level.

The controller determines an R-driving pulse level, a G-driving pulse level and a B-driving pulse level to increase the decreased light levels to 100%. That is, a highest increase of driving pulse level is determined for an LED having a highest decrease of light level, and a lowest increase of driving pulse level is determined for an LED having a lowest decrease of light level.

If the temperature measured at step S210 is ‘T₁’, the R-light has the highest decrease of light level (down to 92% of the reference level) and the B-light level has the lowest decrease of light level (to 99% of the reference level). Accordingly, the R-driving pulse is determined to have the highest increase of pulse level and the B-driving pulse is determined to have the lowest increase of pulse level.

When the determination of the driving pulse levels is complete, the light source driving unit 122 generates driving pulses according to the determined driving pulse levels and supplies the driving pulses to corresponding LEDs at step S230.

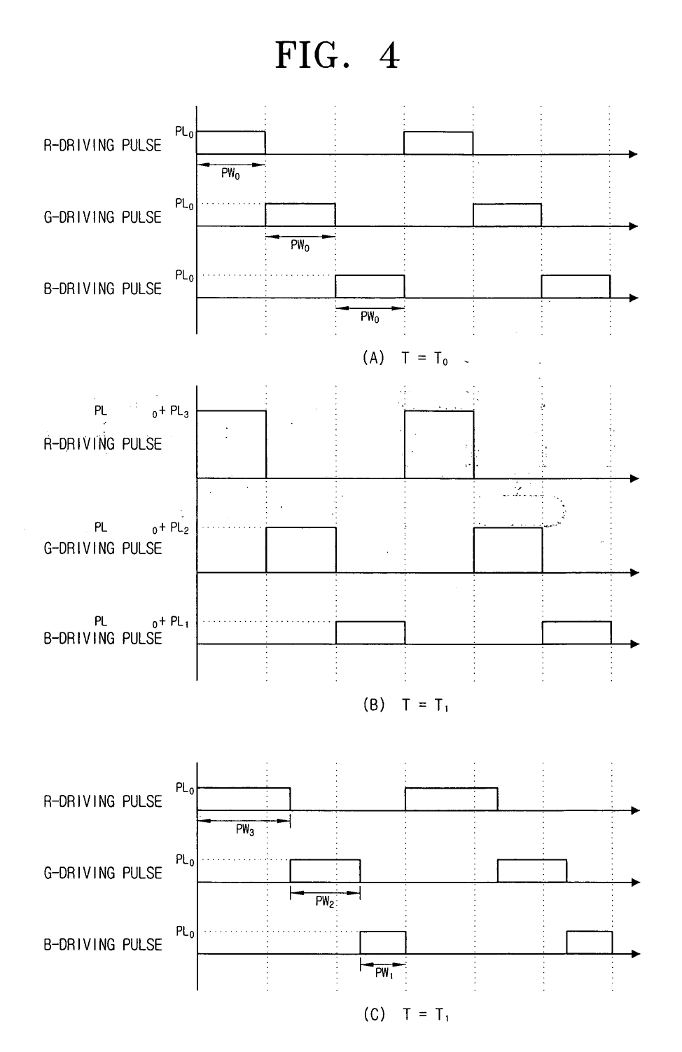

FIG. 4A shows an R-driving pulse, a G-driving pulse and a B-driving pulse generated by the light source driving unit 122 at the beginning of a driving operation with the reference temperature ‘T₀’ of the LED. FIG. 4B shows an R-driving pulse, a G-driving pulse and a B-driving pulse generated by the light source driving unit 122 after a predetermined driving operation with the temperature ‘T₁’ of the LED. As shown in FIG. 4A, since the R-LED, the G-LED, and B-LED have the same light level (100%), all of the R-driving pulse, the G-driving pulse and the B-driving pulse have the same reference pulse level PL₀.

On the other hand, as shown in FIG. 4B, since the R-light has the highest decrease of light level from 100% to 92%, the R-driving pulse has the highest increase of pulse level from PL₀ to PL₀+PL₃. Since the B-light has the lowest decrease of light level from 100% to 99%, the B-driving pulse has the lowest increase of pulse level from PL₀ to PL₀+PL₁. Accordingly, PL₃>PL₂>PL₁.

If the temperature of the LEDs increases to ‘T₁’, the LEDs are driven with the driving pulses as shown in FIG. 4B, thereby returning to approximately 100% of the R-light level, the G-light level and the B-light level. As a result, R-light, G-light, and B-light incident on the image generation unit 180 have the same light amount such that the white balance of an image generated and projected from the image generation unit 180 can be adjusted.

Hereinafter, a white balance adjustment method of an image projection apparatus according to another exemplary embodiment of the present invention will be described with reference to FIG. 2B. FIG. 2B is a flowchart showing a method of adjusting a white balance in consideration of a temperatures of LED according to another exemplary embodiment of the present invention.

Referring to FIG. 2B, a temperature of an LED is measured by a temperature sensor at step S310. Step S310 is essentially the same as step S210, and accordingly its description will be omitted for conciseness.

The controller 130 determines pulse-widths and starting times of driving pulses for the respective LEDs based on the measured temperature at step S320. More specifically, the controller 130 determines a pulse-width and a starting time of an R-driving pulse, a pulse-width and a starting time of a G-driving pulse, and a pulse-width and a starting time of a B-driving pulse based on the measured temperature.

If a certain LED has the highest decrease in light level due to increased temperature, a longest pulse width is determined for the driving pulse of the certain LED. If a certain LED has the lowest decrease in light level, a shortest pulse-width is determined for the driving pulse of the certain LED. If the temperature measured at the step S310 is ‘T₁’, the R-driving pulse width (PW_{R}) is longer than the G-driving pulse width (PW_{G}) and the G-driving pulse width (PW_{G}) is longer than the B-diving pulse width (PW_{B}) (PW_{R}>PW_{G}>PW_{B}).

At step S320, the starting times of the respective driving pulses are determined such that driving pulses having different pulse-widths preferably do not overlap with one another temporally.

When the determination of the pulse-width and the starting timing is complete, the light source driving unit 122 generates driving pulses according to the determined pulse-widths and starting times, and applies them to the corresponding LEDs at step S330.

FIG. 4A shows an R-driving pulse, a G-driving pulse, and a B-driving pulse generated by the light source driving unit 122 at the beginning of a driving operation with the reference temperature ‘T₀’. FIG. 4C shows an R-driving pulse, a G-driving pulse and a B-driving pulse generated by the light source driving unit 122 after a predetermined driving operation with the increased temperature ‘T₁’. In the case of FIG. 4A, since the R-light, the G-light, and the B-light have the same light level (100%), all of the R-driving pulse, the G-driving pulse and the B-driving pulse have the same reference pulse-width PW₀.

On the other hand, in the case of FIG. 4C, since the R-light level is less than the G-light level and the G-light level is less than the B-light level (92%<97%<99%), the R-driving pulse-width is broader than the G-driving pulse-width and the G-driving pulse width is broader than B-driving pulse-width (PW₃>PW₂>PW₁). Also, starting times of the respective driving pulses change such that the R-driving pulse, the G-driving pulse and the B-driving pulse having different pulse widths preferably do not overlap with one another temporally.

If the LEDs are driven with the driving pulses as shown in FIG. 4C at the temperature ‘T₁’, a light-emitting time of the R-LED 114-R having a relatively lower light level is prolonged, while a light-emitting time of the B-LED 114-B having a relatively higher light level is shortened. As a result, the R-light, the G-light, and the B-light incident on the image generation unit 180 have the same light amount such that a white balance of an image generated and projected from the image generation unit 180 is adjusted.

Hereinafter, a white balance adjustment method of an image projection apparatus according to still another exemplary embodiment of the present invention will be described with reference to FIG. 2C. FIG. 2C is a flowchart showing a method of adjusting a white balance in consideration of a temperature of an LED according to an exemplary embodiment.

Referring to FIG. 2C, a temperature of an LED is measured by a temperature sensor at step S410. Step S410 is essentially the same as step S210 as described above, and accordingly a description thereof will be omitted for conciseness.

At step S420, the controller 130 determines levels of reflection angle adjustment signals based on the temperature measured at step S420. The reflection angle adjustment signal adjusts reflection angles of light (R-light, G-light, and B-light) sequentially entering the image generation unit 180 for each pixel. More specifically, at step S420, the controller 130 determines an R-reflection angle adjustment signal level, a G-reflection angle adjustment signal level, and a B-reflection angle adjustment signal level based on the measured temperature, respectively.

The highest increase of reflection angle adjustment signal level is determined for an LED having the highest decrease of light level, such that the light projected from the image generation unit 180 to the projection lens 190 has the highest increase in the light level. On the other hand, the lowest increase of reflection angle adjustment signal level is determined for an LED having the least decrease of light level, such that the light projected from the image generation unit 180 to the projection lens 190 has the lowest increase in the light level.

If the temperature measured at the step S410 is ‘T₁’, the R-reflection angle adjustment signal has the highest increase in the signal level, and thus, the R-light projected from the image generation unit 180 to the projection lens 190 has the highest increase in the light amount. On the other hand, the B-reflection angle adjustment signal has the least increase in the signal level, and thus, the B-light projected from the image generation unit 180 to the projection lens 190 has the least increase in the light amount.

When the determination of reflection angle adjustment signal levels is complete, the image generation driving unit 124 generates reflection angle adjustment signals according to the determined signal levels, and applies them to the image generation unit 180 at step S430.

If the image generation unit 180 is driven with the reflection angle adjustment signals generated at step S430, a light projected to the projection lens 190 with respect to the light having the highest decrease of light level has the highest increase in the light amount, whereas a light projected to the projection lens 190 with respect to the light having the least decrease of light level has the least increase in the light amount. As a result, a white balance of an image generated and projected from the image generation unit 180 is adjusted.

As described above, the temperature of the G-LED 114-G is measured by the G-temperature sensor 116-G provided on the G-panel 112-G, and a white balance is adjusted in consideration of the measured temperature.

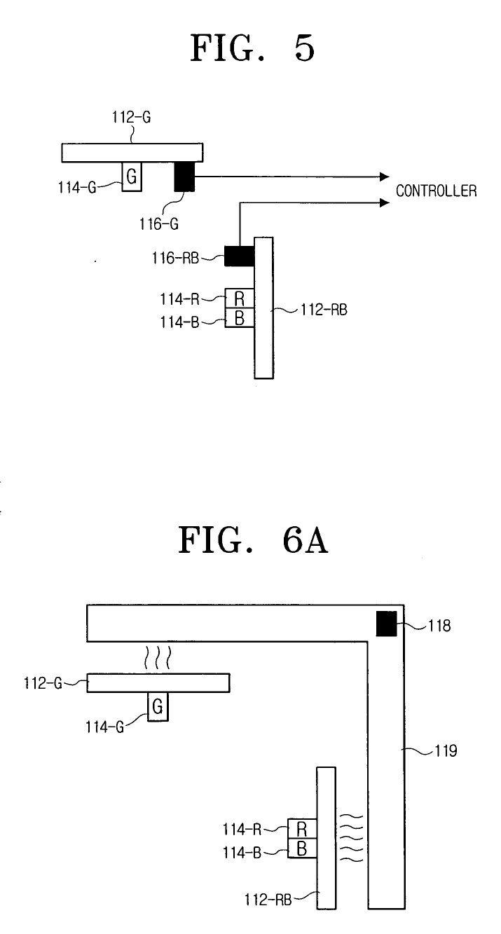

However, it should be understood that there is no limitation to the number of temperature sensors provided in an image projection apparatus according to an embodiment of the present invention. For example, as show in FIG. 5, a RB-temperature sensor 116-RB can be provided on the RB-panel 112-RB to measure temperatures of the R-LED 114-R and the B-LED 114-B.

If there are two temperature sensors in the image projection apparatus as shown in FIG. 5, a G-driving pulse level, a G-driving pulse width or a G-reflection angle adjustment signal level is determined based on the result of measurement of the G-temperature sensor 116-G, and a R-driving pulse level and a B-driving pulse level, a R-driving pulse width and a B-driving pulse width, or a R-reflection angle adjustment signal level and a B-reflection angle adjustment signal level are determined based on the result of measurement of the RB-temperature sensor 116-RB.

Also, there is no limitation on the location of the temperature sensor provided in the image projection apparatus. That is, the temperature sensor does not have to be provided on the RB-panel 112-RB or the G-panel 112-G.

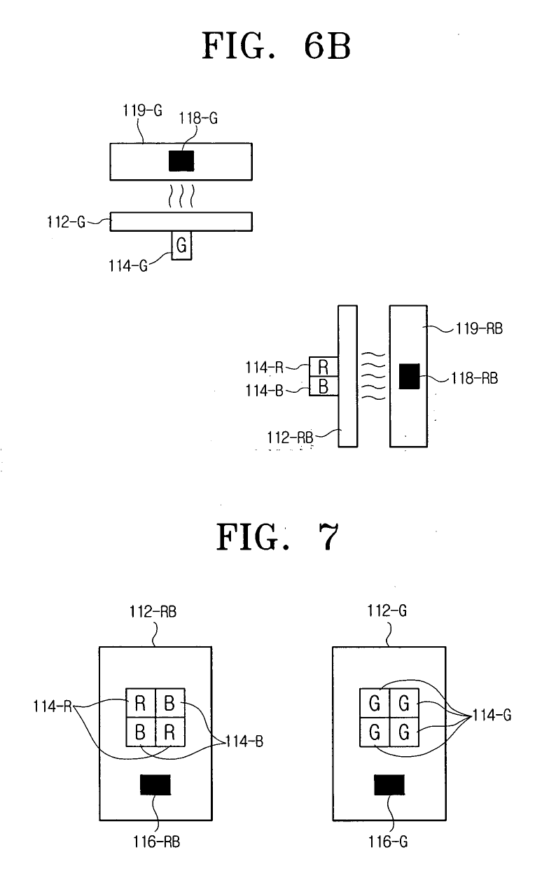

For example, as shown in FIG. 6A, a temperature sensor 118 can be provided on a heat discharging unit 119 for discharging heat generated from the R-LED 114-R, the B-LED 114-B, and the G-LED 114-G to the outside. Alternatively, a temperature sensor 118 can be provided around a heat discharging unit 119. Any suitable arrangement which allows a temperature sensor to sense the temperature of at least one of the LEDs should be considered within the scope of the present invention.

Since the heat discharging unit 119 is preferably embodied by a material of high thermal conductivity, the heat discharging unit 119 has substantially the same temperature regardless of where it is located in or on the hear discharging unit 119. Therefore, the location of the temperature sensor 118 on the heat discharging unit 119 is not important. That is, the temperature sensor 118 can be located in any position of the heat discharging unit 119, including positions on the heating unit 119 or in proximity to the heating unit 119.

As shown in FIG. 6B, if the image projection apparatus has two heat discharging units 119-RB and 119-G, temperature sensors 118-RB and 118-G can be provided on the respective heating units 119-RB, 119-G. If the heat discharging units 119-RB, 119G have similar temperatures, only one of the two temperature sensors 118-RB, 118-G need to be provided and thus, the number of temperature sensors can be reduced.

In the image projection apparatus as shown in FIG. 1, one R-LED 114-R and one B-LED 114-B are both attached to the RB-panel 112-RB, and one G-LED 114-G is attached to the G-panel 112-G. However, this configuration should not be considered limiting. The number of LEDs attached to a panel is not limited, and it is possible to provide a higher number of LEDs and different groupings of LEDs on a panel.

FIG. 7 shows two R-LEDs 114-R and two B-LEDs 114-B attached to a RB-panel 112-RB, and four G-LEDs 114-G attached to a G-panel 112-G. The number (4) of G-LEDs 114-G is preferably two times the number of R-LED 114-R or B-LED 114-B because the light emitted from the G-LED 114-G is typically weaker than the light emitted from the R-LED 114-R or B-LED 114-B in magnitude. However, if a G-LED 114-G of a greater light magnitude is used, the number of G-LEDs 114-G can be the same as that of R-LED 114-R or B-LED 114-B.

In this embodiment, the LEDs are attached to two divided panels. That is, the R-LED 114-R and the B-LED 114-B are attached to the RB-panel 112-RB and the G-LED 114-G is attached to the G-panel 112-G. This configuration is merely exemplary, and is for the convenience of designing the image projection apparatus. It is possible that all of the LEDs may be attached to a single panel. That is, the RB-panel 112-RB and the G-panel 112-G may be integrated into a single panel, and all of the R-LED 114-R, the B-LED 114-B and the G-LED 114-G may be attached to the integrated single panel.

It is possible to realize a projection television using the image projection apparatus described herein. This can be easily implemented by those of ordinary skill in the art, and thus, a detailed description of the same is omitted for conciseness.

As described above, the image projection apparatus according to exemplary embodiments of the present invention are capable of adjusting a white balance in consideration of the temperature of the LED. Therefore, even if the temperatures of the LEDs increase due to prolonged use of the image projection apparatus, a white balance of a projected image is optimally adjusted. As a result, there is minimal image degradation and an optimal image can be provided to a user.

The foregoing embodiments and advantages are merely exemplary and are not to be construed as limiting the present invention. The present teaching can be readily applied to other types of apparatuses not specifically described herein. Also, the description of the exemplary embodiments of the present invention is intended to be illustrative, and not to limit the scope of the claims, and many alternatives, modifications, and variations will be apparent to those skilled in the art.

What is claimed is:

1. An image projection apparatus comprising:
a light source unit to sequentially emit lights generated by a red (R)-light emitting element, a green (G)-light emitting element, and a blue (B)-light emitting element, wherein light levels of the R-light emitting element, the G-light emitting element and the B-light emitting element change depending on changes in temperature;
an image generation unit to generate an image using the lights sequentially emitted from the light source unit and project the image;
a driving unit to drive the light source unit and the image generation unit;
a temperature sensor to measure a temperature of the light source unit; and
a controller to control a driving operation of the driving unit based on the temperature of the light source unit measured by the temperature sensor to adjust a white balance of the image projected from the image generation unit.

2. The image projection apparatus as claimed in claim 1, wherein the temperature sensor is provided near at least one of the R-light emitting element, the G-light emitting element, and the B-light emitting element to measure a temperature of the at least one light emitting element.

3. The image projection apparatus as claimed in claim 2, wherein the temperature sensor is provided on a panel to which at least one of the R-light emitting element, the G-light emitting element, and the B-light emitting element is attached.

4. The image projection apparatus as claimed in claim 1, further comprising a heat discharging unit to discharge heat generated from at least one of the R-light emitting element, the G-light emitting element and the B-light emitting element, wherein the temperature sensor is provided on at least one of the heat discharging unit and a location near the heat discharging unit to measure the temperature of the light source unit.

5. The image projection apparatus as claimed in claim 1, wherein the driving unit comprises a light source driving unit to generate and supply driving pulses for the respective R-light emitting element, G-light emitting element, and B-light emitting element of the light source unit, thereby driving the light source unit, and
wherein the controller determines levels of the driving pulses for the respective R-light emitting element, G-light emitting element, and B-light emitting element based on the temperature of the light source unit measured by the temperature sensor, and controls the light source driving unit to generate the driving pulses according to the determined pulse levels.

6. The image projection apparatus as claimed in claim 1, wherein the driving unit comprises a light source driving unit to generate and supply driving pulses for the respective R-light emitting element, G-light emitting elements, and B-light emitting element, thereby driving the light source unit, and
wherein the controller determines pulse-widths and starting times of driving pulses for the respective R-light emitting element, G-light emitting element and B-light emitting element based on the temperature of the light source unit measured by the temperature sensor, and controls the light source driving unit to generate the driving pulses according to the determined pulse-widths and starting times.

7. The image projection apparatus as claimed in claim 1, wherein the driving unit comprises an image generation driving unit to generate reflection angle adjustment signals to adjust reflection angles for the lights sequentially entering the image generation unit from the light source unit, and to supply the reflection angle adjustment signals to the image generation unit such that the image generation unit generates and projects the image; and
wherein the controller determines levels of the reflection angle adjustment signals based on the temperature of the light source unit measured by the temperature sensor, and controls the image generation driving unit to generate reflection angle adjustment signals according to the determined levels of reflection angle adjustment signals.

8. A method of adjusting a white balance of an image projection apparatus comprising a light source unit to sequentially emit lights generated by a plurality of light emitting elements, wherein light levels of the plurality of light emitting elements changes depending on changes in temperature, and an image generation unit to generate an image using the lights sequentially emitted from the light source unit and project the image, the method comprising:
a) measuring a temperature of the light source unit; and
b) controlling a driving operation of one of the light source unit and the image generation unit based on the measured temperature of the light source unit and thereby adjusting a white balance of the image projected from the image generation unit.

9. The method as claimed in claim 8, wherein step a) comprises using a temperature sensor provided near at least one of the plurality of light emitting elements to measure a temperature of the light emitting element.

10. The method as claimed in claim 9, wherein step a) comprises using a temperature sensor provided on a panel to which at least one of the plurality of light emitting elements is attached and measures a temperature of the light emitting element.

11. The method as claimed in claim 8, wherein step a) comprises using a temperature sensor provided on one of a heat discharging unit and a location near the heat discharging unit to measure a temperature of the light source unit, wherein the heat discharging unit discharges heat generated from at least one of the plurality of light emitting elements.

12. The method as claimed in claim 8, wherein step b) comprises:
determining levels of driving pulses for the respective plurality of light emitting elements based on the measured temperature of the light source unit; and
supplying the driving pulses according to the determined pulse levels to the light source unit and driving the light source unit such that a white balance of the image projected from the image generation unit is adjusted.

13. The method as claimed in claim 8, wherein step b) comprises:
determining pulse-widths and starting times of driving pulses for the respective plurality of light emitting elements based on the measured temperature of the light source unit; and
supplying the driving pulses according to the determined pulse-widths and starting times to the light source unit and driving the light source unit such that a white balance of the image projected from the image generation unit is adjusted.

14. The method as claimed in claim 8, wherein step c) comprises:
determining levels of reflection angle adjustment signals based on the measured temperature of the light source unit, wherein the reflection angle adjustment signals adjust reflection angles for the lights sequentially emitted from the light source unit to the image generation unit; and
supplying the reflection angle adjustment signals according to the determined signal levels to the image generation unit in order for the image generation unit to generate and project the image, such that a white balance of the image projected from the image generation unit is adjusted.
